(19) United States
(12) Patent Application Publication
(10) Pub. No.: US 2024/0239698 A1
(43) Pub. Date: Jul. 18, 2024

(54) METHOD AND SYSTEM FOR TREATMENT OF BRACKISH WATER INLAND DESALINATION BRINE

(71) Applicant: THE REGENTS OF THE UNIVERSITY OF CALIFORNIA, Oakland, CA (US)

(72) Inventors: Haizhou Liu, Irvine, CA (US); Soyoon Kum, San Angelo, TX (US); Xinyu Tang, Riverside, CA (US)

(73) Assignee: THE REGENTS OF THE UNIVERSITY OF CALIFORNIA, Oakland, CA (US)

(21) Appl. No.: 18/410,694

(22) Filed: Jan. 11, 2024

Related U.S. Application Data
(60) Provisional application No. 63/479,446, filed on Jan. 11, 2023.

(51) Int. Cl. C02F 9/00; B01D 61/02; B01D 61/08; B01D 61/14; B01D 61/16; B01D 61/18; B01D 61/58; C02F 1/44; C02F 1/66; C02F 1/72; C02F 5/02

(52) U.S. Cl. CPC C02F 9/00; B01D 61/08; B01D 61/16; B01D 61/18; B01D 61/58; B01D 61/025; B01D 61/147; B01D 2311/04; B01D 2311/08; C02F 1/441; C02F 1/444; C02F 1/66; C02F 1/722; C02F 5/02; C02F 2201/32; C02F 2305/02

(57) ABSTRACT

Methods and systems for treating brackish desalination brine for the recovery of fresh water are disclosed. The method includes treating a source of brackish desalination brine with an ultraviolet-driven persulfate photolysis oxidation pre-treatment; treating the source of brackish desalination brine treated with the ultraviolet-driven persulfate photolysis oxidation pre-treatment to a chemical demineralization process; treating the source of brackish desalination brine treated with the ultraviolet-driven persulfate photolysis oxidation pre-treatment and with the chemical demineralization process to a microfiltration process; and treating the source of brackish desalination brine treated to the ultraviolet-driven persulfate photolysis oxidation pre-treatment, the chemical demineralization process, and the microfiltration process to a reverse osmosis treatment.

### GOVERNMENT CLAUSE

This invention was made with government support under grant number R19AC00092 awarded by the United States Bureau of Reclamation, and grant number 1653931 from the U.S. National Science Foundation. The government has certain rights in the invention.

### TECHNICAL FIELD

The present disclosure generally relates to a method and system for treatment of brackish water inland desalination brine and recoveries of minerals and fresh water using persulfate photolysis, chemical demineralization, and membrane separation.

### BACKGROUND

Freshwater scarcity has become a worldwide challenging issue. To overcome freshwater scarcity in inland and semi-arid areas, including the Middle East, Southern California and Texas, reverse osmosis (RO) membrane desalination of brackish groundwater that contains total dissolved solids (TDS) ranging from 1 g/L to 10 g/L is employed to generate freshwater. Water recovery of brackish water RO desalination is typically between 40% and 85%, depending on TDS and chemical composition of the feed water. Therefore, 15% to 60% of the feedwater becomes the RO concentrate waste, known as brine. However, the management of a RO concentrate stream remains challenging due to the high costs and adverse environmental impacts, especially in inland regions. Current management options for inland desalination plants include ocean or surface water discharge through a brine line, deep well injection, evaporation pond, and landfill solidification. However, the cost of existing brine management can add up to more than 30% of the overall treatment cost, and direct disposal can have negative environmental impacts by increasing salinity and inducing secondary pollution.

In order to minimize the inland brine management cost and negative environmental effects, additional water recovery from brine is needed. The improvement of water recovery can be achieved by passing the primary brine through a secondary RO process. However, the major limitation to achieving high water recovery from the brine is mineral scaling by sparingly soluble salts (e.g., calcite and gypsum) on the membrane surface. Therefore, an adequate brine treatment prior to the further membrane process is necessary to reduce mineral scaling during the secondary RO process.

The major target constituents of brine pre-treatment are antiscalant and scale-forming precursors. Antiscalant is a vital chemical due to its scale inhibition effect, which improves the water recovery of the RO system; therefore, the type of antiscalant applied to the RO system has a significant impact on the operating and maintenance costs in the desalination plants. Choosing the appropriate type of antiscalants depends on the feedwater composition. Among various types of antiscalants, phosphonate-based antiscalants are most commonly added to the feed water. Although antiscalants help prevent precipitation and increase water recovery at the main RO desalination stage, the presence of antiscalants in the brine hinder the removal of target scale-forming precursors at the brine treatment process; therefore, the removal of antiscalant can benefit brine treatment. Several antiscalant separation techniques, including use of coagulant or surfactant, ion exchange, adsorption, nanofiltration, and chemically enhanced seeded precipitation have been proposed. Additional chemical residuals may cause membrane fouling at the secondary RO process. Ion exchange and adsorption still need to be improved for the process sustainability, and antiscalant residual may still present after treatment.

### SUMMARY

In accordance with an exemplary embodiment, antiscalant degradation by advanced oxidation processes (AOPs) can be used to remove phosphonate-based antiscalant compounds. The benefit of AOPs is the decomposition of antiscalants in brine to simple organic compounds. Consequently, both scale inhibition effect during the demineralization process and the possibility of membrane fouling by excessive antiscalant in the RO process can be reduced. Among various AOPs, an ultraviolet-driven persulfate oxidation process (UV/PS) can remove antiscalants rather effectively. UV photolysis of persulfate (S₂O₈²⁻) generates sulfate radical (SO₄^{*-}), and it is a strong oxidant with similar oxidizing power (E⁰=2.5-3.1 V) to HO* (E⁰=1.9-2.7 V). SO₄^{*-} is also more selective toward organic contaminants.

In addition, after antiscalant degradation, the removal of scale-forming precursors in brine can be achieved by demineralization processes. Among various demineralization techniques, chemical demineralization (CDM) is effective in the removal of scale-forming precursors. Alkaline chemicals, e.g., CaO, Ca(OH)₂, NaOH, NaHCO₃, Na₂CO₃ are often used to remove major scale forming precursors including Ca²⁺, Ba²⁺, Mg²⁺, and SiO₂. NaOH softening and lime softening using CaO, Ca(OH)₂, NaHCO₃ or Na₂CO₃ can be beneficial, because these methods only require simple chemical addition; as a result, it allows for the recovery of relatively pure minerals from the sludge of the CDM process. Nonetheless, the kinetics and mechanisms of CDM after antiscalant degradation via UV/PS, and the impact of UV/PS and CDM processes on system water recovery are disclosed as system and method for treating brackish water inland desalination brine and recovery of minerals and fresh water.

In consideration of the above, it would be desirable to: (1) evaluate the applicability of the UV/PS coupled with CDM to degrade antiscalant and remove scale-forming precursors from brackish water desalination brine; (2) determine operating conditions of the UV/PS process (i.e., persulfate dose and UV irradiation time) to degrade antiscalant in the feed water; (3) identify the kinetics and mechanisms of calcium precipitation and calcium removal efficiency by NaOH softening and lime softening methods in the presence and absence of UV/PS pre-treatment at the CDM process; (4) investigate the solid/liquid separation performance of the MF process after CDM in the absence and presence of the UV/PS process, and (5) assess the water recovery potential at RO after UV/PS-CDM process. In accordance with an exemplary embodiment, the performance of the UV/PS-CDM process is disclosed based on technical evaluation metrics, including the settling rate of mineral precipitates at the CDM process, product water quality, and the extent of MF membrane fouling.

A method is disclosed for treating brackish desalination brine, the method comprising: treating a source of brackish desalination brine with an ultraviolet-driven photolysis persulfate photolysis oxidation pre-treatment; treating the source of brackish desalination brine treated with the ultraviolet-driven persulfate photolysis oxidation pre-treatment to a chemical demineralization process; treating the source of brackish desalination brine treated with the ultraviolet-driven persulfate photolysis oxidation pre-treatment and with the chemical demineralization process to a microfiltration process; and treating the source of brackish desalination brine treated to the ultraviolet-driven persulfate photolysis oxidation pre-treatment, the chemical demineralization process, and the microfiltration process to a reverse osmosis treatment.

A method is disclosed for treating brackish desalination brine for a reverse osmosis treatment for recovery of fresh water, the method comprising: treating a source of brackish desalination brine with an ultraviolet-driven persulfate photolysis oxidation pre-treatment, the ultraviolet-driven persulfate photolysis oxidation pre-treatment includes adding persulfate to the source of brackish desalination brine, and exposing the source of brackish desalination brine with the persulfate to ultraviolet irradiation; adjusting a pH of the source of brackish desalination brine treated with the ultraviolet-driven persulfate photolysis oxidation pre-treatment; treating the pH adjusted source of brackish desalination brine to a chemical demineralization process; and treating the source of brackish desalination brine treated with the chemical demineralization process to a microfiltration process.

A system is disclosed for recovering fresh water from a source of brackish desalination brine, the system comprising: a source of ultraviolet light, the source of ultraviolet light configured to treat the source of brackish desalination brine with added persulfate to an ultraviolet-driven persulfate photolysis oxidation pre-treatment process; a chemical demineralization system configured to treat the source of brackish desalination brine treated with the ultraviolet-driven persulfate photolysis oxidation pre-treatment to a chemical demineralization process; a microfiltration system, the microfiltration system configured to separate the source of brackish desalination brine treated with the ultraviolet-driven persulfate photolysis oxidation pre-treatment and with the chemical demineralization process into solids and a liquid; and a reverse osmosis system configured to treating the liquid from microfiltration process with a reverse osmosis treatment to recover the fresh water from the liquid.

### BRIEF DESCRIPTION OF THE DRAWINGS

FIG. 1 is a schematic of the UV/PS-CDM-MF brine pre-treatment in accordance with an exemplary embodiment.

FIGS. 2A and 2B are illustrations of contribution of persulfate dose to DTPMP degradation where FIG. 2A illustrates the effect of UV/persulfate on DTPMP degradation and FIG. 2B is observed pseudo-first-order rates of DTPMP degradation. Experimental condition: Synthetic brine, [Ionic strength]=98 mM; [DTPMP]₀=0.1 mM; [Persulfate]₀=2.0-5.0 mM; initial pH=7.8; Error bars represent the range of values for triplicate tests.

FIGS. 3A and 3B are illustrations of total calcium concentration of CDM process by NaOH softening with 5 M NaOH, where FIG. 3A illustrates the CDM process with UV/PS pre-treatment at pH 7.8, pH 9, and pH 10.2; and FIG. 3B illustrates the CDM process for controls and CDM process with UV/PS pre-treatment at pH 10.2. Note: after chemical addition (time zero), each solution was rapid-mixed at 700 rpm for 1 minute to allow chemical mixing and precipitation to occur and then sit for 29 mins for sedimentation (that is, a total elapsed time of 30 mins); Error bars represent the range of values for triplicate tests.

FIG. 4 is an illustration of total calcium concentration of the CDM process by lime softening (16.5 mM of Ca(OH)₂ and 11.7 mM of NaHCO₃). Note: after chemical addition (time zero), each solution was rapid-mixed at 700 rpm for 1 minute to allow chemical mixing and precipitation to occur and then sit for 29 mins for sedimentation (that is, a total elapsed time of 30 mins); Error bars represent the range of values for triplicate tests.

FIGS. 5A and 5B are illustrations of total calcium concentration change during the CDM process after 0, 5, 10, and 20 minutes UV/PS pre-treatment, where FIG. 5A illustrates NaOH softening at pH 10.2; and FIG. 5B illustrates lime softening (16.5 mM of Ca(OH)₂ and 11.7 mM of NaHCO₃). Note: after chemical addition (time zero), each solution was rapid-mixed at 700 rpm for 1 minute to allow chemical mixing and precipitation to occur and then sit for 29 mins for sedimentation (Total 30 mins); Error bars represent the range of values for triplicate tests.

FIGS. 6A and 6B are illustrations of normalized permeate flux decline as a function of cumulative normalized volume throughput in the solutions of FIG. 6A illustrating NaOH softening (5 M NaOH, pH 10.2) and FIG. 6B illustrating lime softening demineralization without and with UV/PS pre-treatment.

FIG. 7 is an illustrates calcite saturation index calculations for calcite in the treated brine after UV/PS-CDM (NaOH softening) and UV/PS-CDM (lime softening). Control stands for no UV/PS-CDM treatment (direct use of brine). Saturation index calculations were performed through Visual Minteq (Version 3.1) for a pH of 7.8 with 100% salts rejection rate at the additional RO process. Note: the ordinate is a saturation index, and it is a logarithmic number.

FIG. 8 is Table 1, which illustrates chemical composition of brackish water desalination brine solutions in accordance with an exemplary embodiment.

FIG. 9 is an illustration of a comparison of processes of no brine treatment versus a brin treatment in accordance with an exemplary embodiment.

FIG. 10 is a schematic of sequential persulfate-based photochemical pre-treatment, chemical demineralization, microfiltration, and reverse osmosis (UV/PS-CDM-MF-RO) system.

FIGS. 11A and 11B are illustrations of antiscalant degradation by UV/persulfate treatment where FIG. 11A illustrates the effect of UV irradiation time and FIG. 11B illustrates observed pseudo-first-order rates of antiscalant degradation. Experimental condition: [Persulfate]₀=0-4.0 mM; initial pH=7.8. Note: orthophosphate concentration was measured as an indicator of phosphonate antiscalant degradation and error bars represent the range of values for triplicate tests.

FIGS. 12A and 12B are illustrations of total calcium and magnesium concentration of CDM process after adjustment to pH 10.2 with 5 M NaOH where FIG. 12A is calcium and FIG. 12B is magnesium. Note: after chemical addition (time zero), each solution was rapid-mixed at 700 rpm for 1 min to allow chemical mixing and precipitation to occur and then sit for 29 min for sedimentation (that is, a total elapsed time of 30 mins); Error bars represent the range of values for triplicate tests.

FIGS. 13A and 13B illustrate recovered solid amount after CDM process where FIG. 13A illustrates total recovered dry solid concentration, and FIG. 13B illustrates mass percentage of calcite, dolomite, and silica in the recovered dry solids. The amount of different solids was calculated based on ICP-MS measured concentrations of calcium, magnesium, and silica in the digested samples.

FIGS. 14A-14C illustrate normalized permeate flux decline as a function of water recovery for RO feed solutions where FIG. 14A has a pH of 7.8, FIG. 14B has a pH of 5, and FIG. 14C has a pH of 10.2. Note: CDM indicates the CDM process without UV/PS pre-treatment and UV/PS-CDM indicates the CDM process with UV/PS pre-treatment. The RO process was operated for 24 h.

FIG. 15 is Table 2, which illustrates major chemical constituents of the inland brackish reverse osmosis (RO) brine in accordance with an exemplary embodiment.

FIG. 16 is Table 3, which illustrates total dissolved solids (TDS) of the reverse osmosis (RO) permeate without and with UV/PS pre-treatment prior to CDM in accordance with an embodiment.

### DETAILED DESCRIPTION

Set forth below with reference to the accompanying drawings is a detailed description of embodiments of a method and system for treatment of brackish water inland desalination brine and recoveries of minerals and fresh water using persulfate, chemical demineralization, and membrane separation. Note that since embodiments described below are preferred specific examples of the present disclosure, although various technically preferable limitations are given, the scope of the present disclosure is not limited to the embodiments unless otherwise specified in the following descriptions.

Brine disposal is a challenging issue for brackish water desalination in inland regions. This disclosure relates to an ultraviolet-driven persulfate oxidation pre-treatment (UV/PS) followed by a chemical demineralization (CDM) and microfiltration to effectively treat brackish water desalination brine, specifically by degrading antiscalant during UV/PS and precipitating scale-forming calcium from the brine during CDM. To optimize calcium removal kinetics, the effects of persulfate dose and UV irradiation time during UV/PS were investigated and softening by NaOH and lime during CDM were evaluated. UV/PS pre-treatment successfully eliminated the scale inhibition effect of antiscalant, resulting in an enhanced chemical demineralization performance. In accordance with an embodiment, a few minutes (e.g., at least 2 minutes) of CDM operating time was sufficient to remove more than 85% of total calcium from the brine due to the fast sedimentation of calcium precipitates. Moreover, compared to a control (no pre-treatment), the subsequent microfiltration (MF) membrane fouling potential was reduced by 80%. Overall, the application of the UV/PS-CDM-MF combined process has the potential to remove more than 90% of calcium from the brackish desalination brine, and consequently recover a significant amount of fresh water (>90%) from the brine. Results from this disclosure point to UV/PS-CDM process as a promising brine treatment technology to remove scale-forming precursors and improve water recovery.

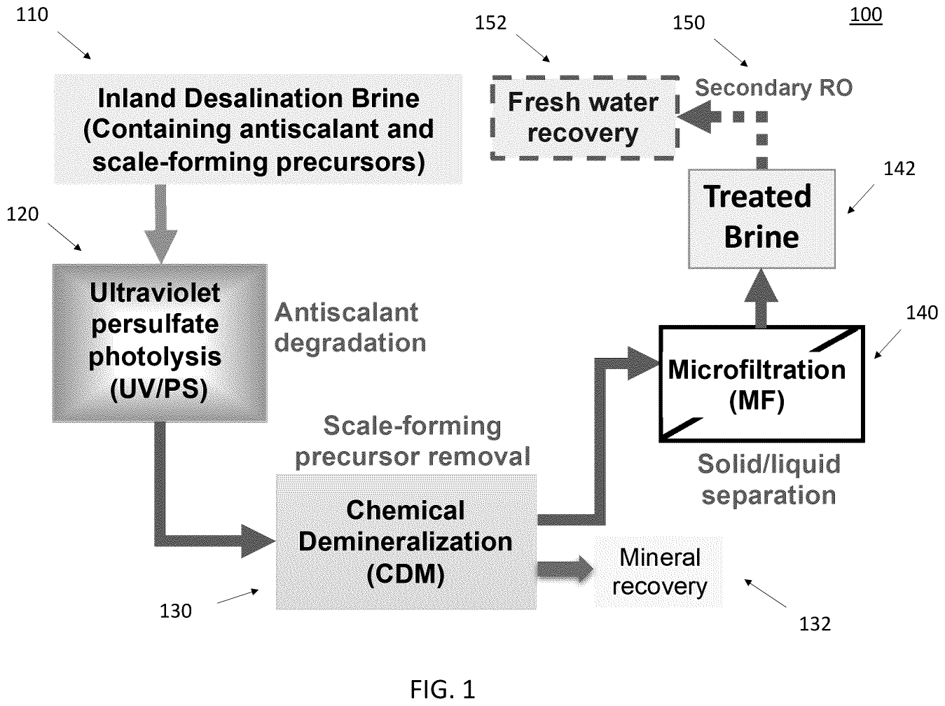

FIG. 1 is a schematic of the UV/PS-CDM-MF brine pre-treatment 100 in accordance with an exemplary embodiment. As shown in FIG. 1, the pre-treatment 100 can include a method for treating brackish desalination brine can include a source of inland desalination brine (or brackish desalination brine) 110 containing antiscalant and scale-forming precursors. The method can include treating the source of brackish desalination brine 110 with an ultraviolet-driven persulfate oxidation pre-treatment (or ultraviolet persulfate photolysis (UV/PS) 120, a chemical demineralization process 130, a microfiltration process 140, and a reverse osmosis (RO) treatment (or secondary RO) 150. The ultraviolet-driven persulfate oxidation pre-treatment (or ultraviolet persulfate photolysis (UV/PS) 120 causes antiscalant degradation of the antiscalant of the desalination brine 110. The chemical demineralization process 130 removes the scale-forming precursors in the form a mineral recovery 132. The microfiltration process 140 separates the solids from the liquid in the UV/PS and chemical demineralization brine to form a treated brine 142. The treated brine 142 can be treated with the reverse osmosis (RO) treatment (or secondary RO) 150 to recover fresh water 152 from the treated brine 142.

### Materials and Methods

### Chemicals and Solutions

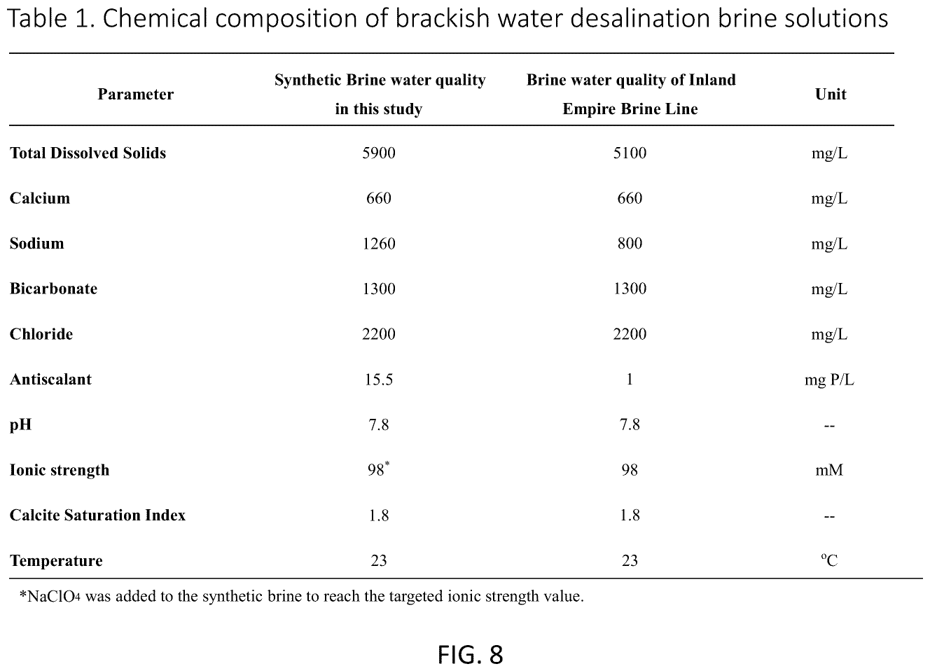

Stock solutions and synthetic brine feed water were prepared using Milli-Q water. All chemicals were reagent grade or higher and obtained from JT Baker, Sigma-Aldrich, or Fisher Scientific. Synthetic brine solutions were prepared to simulate the chemical composition of inland brackish groundwater RO concentrate at the Inland Empire Brine Line in Riverside, California, USA. Details of brine water quality are listed in Table 1 (FIG. 8). The use of synthetic feed water allowed a fundamental investigation of the calcium carbonate precipitation, which is a major supersaturated solid in inland desalination brines. Diethylenetriamine pentamethylene phosphonic acid (DTPMP) was chosen as a representative phosphonate-based antiscalant to prepare the synthetic brine, because DTPMP is a widely used antiscalant in membrane treatment and exhibits a strong scaling inhibition effect.

### Experimental Setup

The brine treatment process consisted of a UV/PS pre-treatment to degrade antiscalant, a CDM step to remove scaling components, and a microfiltration (MF) step to separate scaling minerals from the treated brine (FIG. 1). For UV/PS experiments, a 4-L beaker UV reactor equipped with a 450-W medium pressure UV immersion lamp (Ace Glass, Inc.) was utilized. To start an experiment, a 3.5-L synthetic brine solution containing 2-5 mM persulfate and 0.1 mM DTPMP (equivalent to 15.5 mg/L as organic phosphorus) was exposed to UV irradiation that last up to 60 minutes. The initial and final pH of the brine solutions was 7.8 and 6.7, respectively. The chosen concentration of DTPMP was at the higher end of typical phosphonate-based antiscalant concentration observed in RO brine. During UV/PS experimentation, 3-mL samples were withdrawn by pipette from the experimental reservoirs at each targeted reaction time interval.

Following the UV/PS experiment, 1 L of the UV/PS treated brine underwent a CDM process in a 2-L stirred rectangular batch reactor. For the UV/PS pre-treatment prior to the CDM process, 4 mM persulfate and 5, 10, or 20 minutes of UV irradiation time were employed. In addition, two control CDM experiments were conducted using a synthetic brine without UV/PS pre-treatment (control—no UV/PS pre-treatment), and a synthetic brine in the absence of antiscalant without UV/PS pre-treatment (control—no antiscalant). Two chemical demineralization methods were evaluated for the CDM process, e.g., NaOH softening and lime softening. For the NaOH softening method, a targeted amount of NaOH was added to adjust the pH of the UV/PS-treated brine to either 7.8, 9.0 or 10.2 with prior to CDM process. pH 7.8 is synthetic RO brine feedwater pH (Table 1 (FIG. 8)), pH 10.2 is where the plateau of the calcium carbonate saturation index in the brine started, and pH 9 is the middle point of those two pHs. For the lime softening method, a requisite amount of Ca(OH)₂ and NaHCO₃ in combination was added to the UV/PS-treated brine. Immediately after chemical addition, the brine was rapid-mixed at 700 rpm for 1 minute to allow chemical mixing, followed by 29 minutes of sedimentation (i.e., a total of 30 mins of CDM process). At targeted time intervals during the CDM process, 3-mL samples were withdrawn from the batch reactor at 3 cm below the water-air interface using a pipette, which minimized the stirring impact on the reactor. All samples were immediately acidified with 100 μL of concentrated HNO₃ and preserved for total calcium analysis.

Following the CDM process, a microfiltration (MF) step was conducted to evaluate the impact of the UV/PS-CDM treatment on the solid/liquid separation process from the treated brine. Specifically, the CDM treated brine further underwent a dead-end microfiltration (MF) process to separate residual particles in the supernatant. Based on the CDM process results, the solid/liquid separation was performed 3 minutes of the lime softening CDM process and 5 minutes after the start point of NaOH softening CDM process with different UV/PS pre-treated brines. The experimental setup consisted of 0.1-μm polyvinylidene fluoride membrane (Millipore Sigma, Burlington, MA), pressurizing equipment (nitrogen gas tank, pressure gauge, and pressure control valve), a 200 mL stirred cell (Millipore Sigma, Burlington, MA), and a permeate collection line. The permeate flux was measured continuously by a digital mass balance. Membrane permeate flux and relative permeate flux were calculated using equations 1-2, respectively:

$$J = \frac{M}{At} \qquad ( E 1 )$$

$$Relative permeate flux = \frac{J}{{J}_{0}} \qquad ( E2 )$$

Where J is the permeate flux (g cm⁻² sec⁻¹), M is total mass of permeate (g), A is membrane area (cm²), t is experimental time (sec), and J₀ is initial permeate flux (g cm⁻² sec⁻¹).

### Analytical Methods for Water Samples

During the UV/PS pre-treatment, the concentration of persulfate in the brine was determined by a colorimetric method using potassium iodide. The concentration of DTPMP in the brine was calculated by measuring orthophosphate concentration using Standard method 4500-P E, since orthophosphate is the final phosphorus oxidation product. During the CDM experimental step, the solid precipitation and sedimentation were monitored by measuring the change of total calcium concentration at pre-determined time intervals. The total calcium concentration in the sampled solutions was determined using an Inductively Coupled Plasma Mass Spectroscopy (ICP-MS, Agilent Technologies, Palo Alto, CA).

### Results and Discussion

### Antiscalant DTPMP Degradation by UV/Persulfate

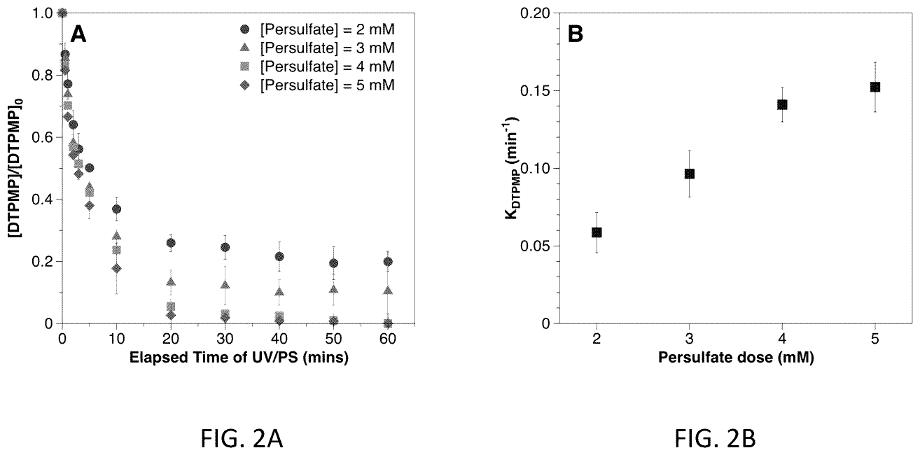

DTPMP was successfully degraded in synthetic brine as the brine was irradiated in the UV/persulfate system (FIG. 2A). The degradation of DTPMP followed a pseudo first-order kinetics model (all R²>0.95). The observed pseudo first-order rates of DTPMP degradation increased from 5.9×10⁻² to 9.6×10⁻² min⁻¹ as the persulfate dosage increased from 2 to 5 mM (FIG. 2B). Persulfate photolysis generates SO*₄⁻ (Reaction 1 (R1)), which further hydrolyzes to HO* (Reaction 2; k₂=6.5×10⁷ M⁻¹s⁻¹):

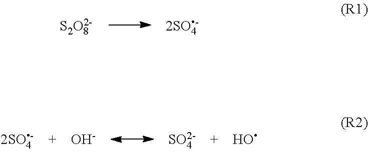

A persulfate dosage equal or higher than 4 mM completely degraded DTPMP in 30 minutes UV irradiation time; however, a persulfate dosage less than 4 mM were not enough to completely degrade 0.1 mM DTPMP (FIG. 2A), due to an insufficient generation of reactive radicals via persulfate photolysis (R1-R2).

SO*₄⁻ and HO* can be scavenged by persulfate (Reactions 3-4 (R3-R4); k₃=5.5×10⁵ M⁻¹s⁻¹; k₄=1.4×10⁷ M⁻¹s⁻¹), respectively, and generate non-reactive persulfate radical S₂O₈^{*-}:

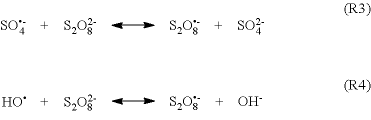

This scavenging impeded the degradation of DTPMP with increasing persulfate dosage; therefore, the rate constant of DTPMP degradation increased at a slower pace as the persulfate dosage increased beyond 4 mM (FIG. 2B). Because more than 90% of DTPMP was degraded after 20 minutes of persulfate photolysis with 4 mM persulfate dosage (FIG. 2B), 4 mM dosage of persulfate was chosen for subsequent UV/PS-CDM experiments.

### Chemical Demineralization by NaOH Softening

Calcium carbonate is a major precipitate from the brine, and the precipitation of calcium carbonate is dictated by pH of the solution as a result of carbonate speciation. The saturation index (SI, the logarithm value of the saturation state) of calcium carbonate of the brine was approximately 1.8, indicating precipitation is thermodynamically favorable (SI>0). When NaOH is added to the brine to increase pH, chemical demineralization occurs via calcium carbonate precipitation (Reactions 5-7 (R5-R7)):

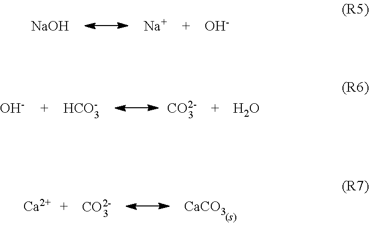

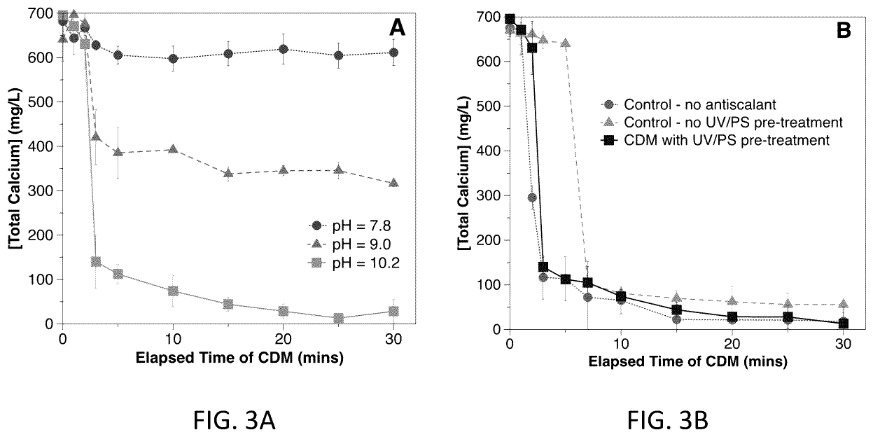

Therefore, the saturation index of calcium carbonate mineral increases as pH increases. Experimental data showed that total calcium residual in the brine exhibited the biggest decrease when the brine pH was adjusted to 10.2 during the CDM process (FIG. 3A). When the brine pH increased from pH 7.8 to pH 10.2, the dominant carbonate species switches from HCO₃⁻ to CO₃²⁻ and promoted calcium precipitation (R5-R7).

In comparison with the control without UV/PS pre-treatment, the UV/PS pre-treatment was shortening the settling time of calcium precipitates during the CDM process and achieved the lowest final calcium concentration (FIG. 3B). In addition, the total calcium removal from the UV/PS pre-treated brine during the CDM process exhibited a similar reaction kinetics in comparison to the CDM control without antiscalant (FIG. 3B). These trends suggested that the degradation of DTPMP during the UV/PS pre-treatment promoted calcium removal during the CDM process. The presence of DTPMP has a detrimental effect on the calcium removal and delayed the sedimentation of calcium precipitates during the CDM (Control without UV/PS pre-treatment in FIG. 3A). Antiscalants interfere with the complete particle growth by adsorbing onto nucleating crystals and blocking the crystal growth sites.

### Chemical Demineralization by Lime Softening

Chemical demineralization via lime softening introduces additional calcium in the form of hydrated lime Ca(OH)₂ into the system and induces calcium carbonate precipitation (Reactions 8-10 (R8-R10)):

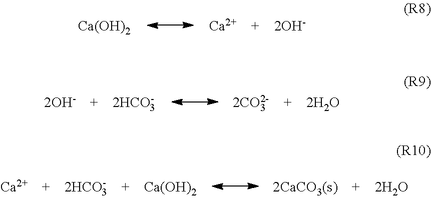 [SMILES: "Ca(OH)2" ; [Ca+2] ; "2OH-" ; [Ca+2] ; "Ca(OH)2" ; "2CaCO3(s)"]

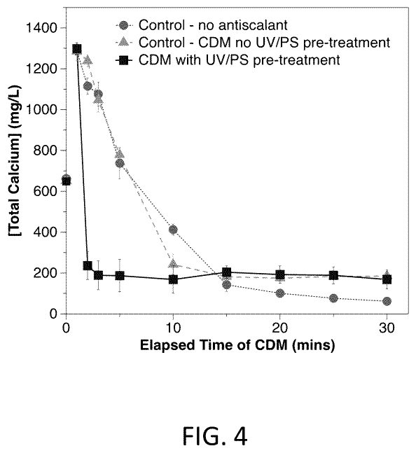

Since additional calcium was added for demineralization, total calcium concentration increased initially during the first one minute and then decreased as reactions took place (FIG. 4). During the lime softening CDM process, total calcium concentration in the UV/PS pre-treated brine exhibited the fastest removal in comparison to controls (FIG. 4). The settling of calcium precipitates mostly took place during the first 3 minutes of the CDM process. In contrast, no calcium removal was achieved after 15 minutes of CDM process in the two control experiments.

In addition, as DTPMP was degraded to orthophosphate during the UV/PS pre-treatment, the formation of orthophosphate accelerated total calcium removal during the CDM process. In a separate control experiment by adding orthophosphate to the brine prior to the CDM process, the effects of orthophosphate addition on the kinetics of total calcium removal were similar to UV/PS pre-treatment, which behavior has been observed for both NaOH softening and lime softening. The formation of orthophosphate resulted in the supersaturation and precipitation of hydroxyapatite Ca₅(PO₄)₃OH(s) in the brine (saturation index>14.4), which could accelerate the nucleation and precipitation of calcium solids. Therefore, the UV/PS pre-treatment both removed the inhibitive effect of DTPMP on calcium precipitation and accelerated additional calcium phosphate mineral nucleation, both of which contributed to the total calcium removal during the CDM process.

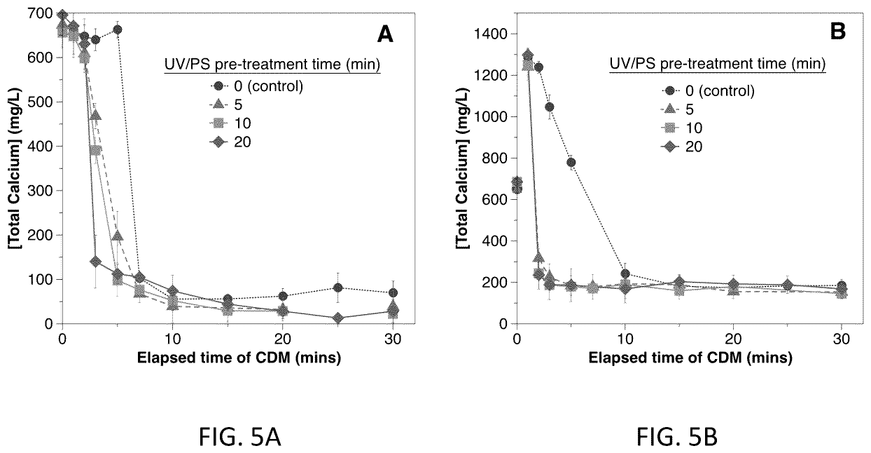

The effect of varying UV irradiation time during the UV/PS pre-treatment on total calcium removal via the CDM process was also investigated. Results showed that an increased in the UV irradiation time led to better total calcium removal during the NaOH softening CDM process (FIG. 5A). For the lime softening CDM process, notably a faster settling was achieved with UV/PS pre-treatment regardless of the UV irradiation time (FIG. 5B), indicating that a partial degradation of DTPMP also accelerated the demineralization process.

### Microfiltration Performance Following Chemical Demineralization

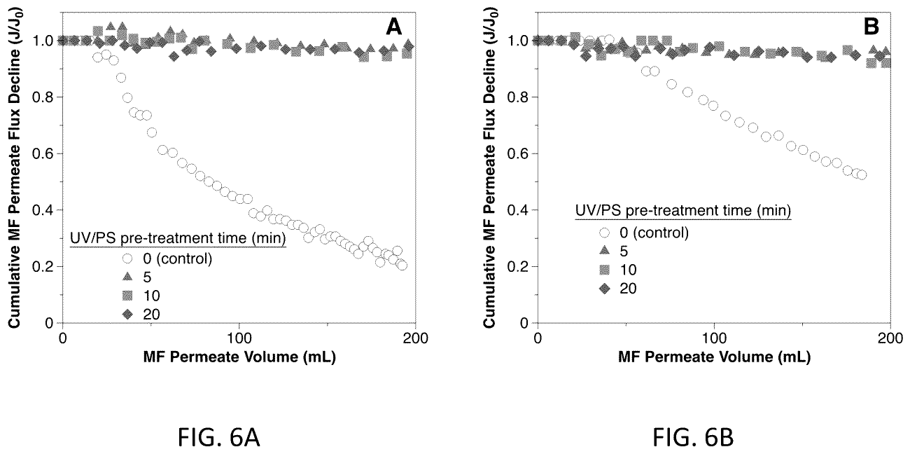

The CDM-treated brine further underwent a MF process and the effect of UV/PS pre-treatment on the MF performance was evaluated. Results showed that the MF permeate flux maintained at a high level and exhibited little decline when the brine was pre-treated with the UV/PS as the first step (FIGS. 6A and 6B). This trend suggested that the UV/PS pre-treatment significantly alleviated particle scaling on the MF membrane surface. Because the UV/PS pre-treated brine exhibited a fast settling of calcium solids and a majority of the solids were removed during the first 5 minutes of the CDM process, the combined UV/PS-CDM treated brine feeding into the MF step had minimal suspended solids. Consequently, the MF permeate fluxes showed a minimal decline. In contrast, the brine without UV/PS pre-treatment exhibited a severe flux decline (50% to 80% decrease) during the MF separation (FIGS. 6A and 6B). Without antiscalant degradation by the UV/PS pre-treatment, a significant amount of precipitates remained after the CDM process in the solution due to slow settling rate, which induced fouling on the MF membrane by precipitates and promotes a denser fouling cake. The less fouling on the MF membrane indicates that increase in product water yield, less frequent membrane backwashing and replacement, and reduced MF operation cost.

### Engineering Implications on Freshwater Recovery

The application of the UV/PS pre-treatment followed by a CDM process improves the permeate flux during the MF step due to a low calcium concentration in the MF permeate. The MF permeate can further undergo an additional RO step to recover freshwater from the sequential UV/PS-CDM-MF treated brine. The extent of water recovery via this additional RO step may be limited by calcite mineral scaling on the RO membrane, which can be predicted based on the theoretical calculations on the saturation index (SI) of calcite in the UV/PS-CDM-MF treated brine (i.e., RO feed brine). Calcite is oversaturated in the untreated brackish desalination brine and its oversaturation leads to membrane scaling during the RO step and limits water recovery. Specifically, water recovery can be continuously achieved via the additional RO system in the absence of antiscalant when the calcite SI of the feed brine is below zero, i.e., the sequential UV/PS-CDM-MF treated brine is undersaturated with respect to calcite. Furthermore, additional antiscalant can be added to the UV/PS-CDM-MF treated brine to alleviate calcite scaling. The upper operating limit of calcite SI in the feed water to a conservative RO system in the presence of antiscalant can be recommended, for example, to be 1.8.

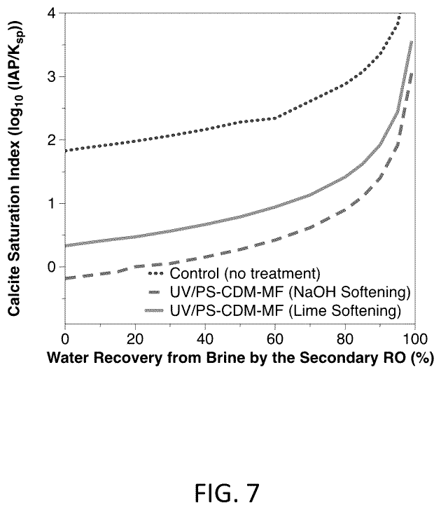

Calculations show that the calcite SI of the untreated brine (control without treatment), UV/PS-CDM-MF treated brine (via lime softening during the CDM process) and UV/PS-CDM-MF treated brine (via NaOH softening during the CDM process) was 1.8, 0.3 and −0.2, respectively (FIG. 7). This suggests that that the untreated brine is an unfavorable condition for additional water recovery. When an antiscalant is added during the additional RO step to recover freshwater from the treated brine, the NaOH softening based UV/PS-CDM-MF treatment train can achieve more than 90% freshwater recovery until the SI limit (i.e., a value of 1.8) of antiscalant inhibition is reached (FIG. 7). Similarly, the lime softening based UV/PS-CDM-MF treatment train can achieve more than 85% freshwater recovery until the SI limit is reached (FIG. 7).

The performance of the sequential UV/PS-CDM-MF treatment train process was evaluated and compared to control experiments. The results show that the UV/PS-CDM-MF in combination is a promising inland desalination brine treatment technology to remove oversaturated calcium and increase the freshwater recovery potential via an additional RO step. UV/persulfate process effectively degraded phosphonate-based antiscalant. In addition, the CDM process after UV/PS pre-treatment achieved faster settling rate of calcium precipitates due to antiscalant degradation by the UV/PS pre-treatment. Both NaOH-softening and lime-softening based CDM methods prevent flux decline during the subsequent microfiltration step and extend the duration of operation during the calcium solid/treated brine separation process. The application of the UV/PS-CDM-MF treatment process has the potential to remove more than 90% calcium from inland desalination brine. As a result, a very high-water recovery (>90%) by an additional RO process is expected. Future work will evaluate the applicability of the UV/PS-CDM-MF-RO treatment train for freshwater recovery and hardness mineral recoveries from inland desalination brine.

In addition, managing reverse osmosis (RO) brine generated from inland brackish desalination plants is challenging and critical to minimize adverse environmental impacts of brine disposal. This disclosure further disclosure the use of a brine treatment train with an ultraviolet-driven persulfate oxidative (UV/PS) pre-treatment followed sequentially by chemical demineralization (CDM), microfiltration (MF) and secondary RO to achieve antiscalant degradation, scale-forming ions removal, mineral recovery, and additional water recovery from an inland brackish RO brine. Results showed that the UV/PS pre-treatment successfully degraded the phosphonate antiscalant in the RO brine within 20 min of UV irradiation. The UV/PS pre-treatment improved mineral resources recovery from the brine in a subsequent CDM process. Analyses of the recovered minerals revealed that Ca, Mg, and Si were the major chemical components, and calcite was a major crystallized mineral. The CDM process with UV/PS pre-treatment mitigated membrane fouling and improved water recovery during a subsequent RO step, due to the lower magnesium and silica concentrations and the removal of phosphonate antiscalant. The results demonstrated the benefits and applicability of a persulfate-based photochemical treatment followed by CDM, MF, and RO for inland brackish water brine treatment and recovery of additional water.

Climate impact and rapid population growth are causing severe water scarcity, and the shortage of available freshwater has become a substantial issue worldwide. In semi-arid inland areas suffering freshwater scarcity, including the Middle East and the Southwestern U.S., brackish groundwater is used as an alternative water sources to produce potable water via reverse osmosis (RO) processes. Depending on the feedwater salinity and chemical constituents, water recovery of the brackish water RO process usually ranges between 40% and 85%, resulting in the inevitable generation of a desalination concentrate (also known as brine) that needs disposal.

Disposal of inland brackish desalination brine is challenging due to the cost and potential unfavorable environmental impacts. Current options for inland desalination plants include deep well injection, evaporation pond, land application, ocean discharge via pipeline, and advanced brine treatment. Deep well injection and land application are relatively simple brine disposal methods; however, direct brine disposal can cause negative environmental impacts by increasing salinity and inducing secondary pollution. Evaporation ponds are a suitable RO brine management option for regions where solar energy is abundant, but the large land requirement prohibits its application in densely populous urban areas. Although the use of a brine line could be ideal for the centralized treatment of RO brine, accessibility to an existing brine line is limited in many regions.

In order to minimize the inland brine management cost and adverse environmental effects, advanced brine treatment is indispensable. Inland brackish RO brine has a unique chemistry—containing a high level of various scale-forming ions including calcium and magnesium, and a moderate salinity, with the total dissolved solids (TDS) concentration ranging from 5000 mg/L to 15,000 mg/L. The brine is often oversaturated with respect to calcium and magnesium minerals. Additionally, RO brine contains antiscalants typically composed of phosphonates that are added to the feedwater with the majority of chemical components being rejected by the non-porous membranes. The concentration of antiscalants in the brine can be six times higher than its original concentration in the RO feed (in the case of 85% water recovery associated with three-stage RO and 99% antiscalant rejection). The existence of a high concentration of residual antiscalants in the brine not only inhibits the removal of scale-forming ions and recovery of hardness minerals during treatment, but also increases the risk of biofouling during the secondary RO process for additional water recovery. Therefore, the removal of antiscalants needs to be targeted in advanced brine treatment for additional resources and water recovery.

Additional water recovery from RO brine can be achieved by various membrane-based separation processes including RO, forward osmosis, membrane distillation, and electrodialysis. Mineral resources recovery from RO brine can be realized by chemical precipitation and crystallizers. Prior studies investigated combined treatment trains to achieve both water and resources recovery from RO brine, including electrodialysis reversal with a crystallizer, membrane distillation crystallization, and RO with chemically enhanced seeded precipitation. However, the effects of the removal of antiscalants from RO brine on water and resources recovery remains largely unknown.

Advanced oxidation processes (AOPs) have been recently investigated to degrade phosphonic acid-based antiscalants. Among various AOPs, an ultraviolet-driven persulfate oxidation process (UV/PS) has attracted significant scientific interest for the destruction of organic compounds in the aquatic system and shown the potential to remove phosphonate antiscalants effectively. UV photolysis of persulfate (S₂O₈²⁻) generates a strong oxidant—a sulfate radical (SO₄^{*-})—similar in oxidizing power (E⁰=2.5-3.1 V) to HO* (E⁰=1.9-2.7 V), and more selective than HO* toward organic pollutants.

In accordance with an embodiment, once the antiscalants are degraded by UV/PS AOP, precipitation of scale-forming ions including calcium and magnesium can be enhanced via a chemical demineralization (CDM) process with pH adjustment to accelerate precipitation of minerals for resources recovery. As a direct result of hardness ions removal, the RO brine has significantly less scaling potential and therefore can undergo secondary RO for additional water recovery. Until now, the application of the CDM process with UV/PS pre-treatment on RO brine treatment has not been evaluated.

Accordingly, the objectives of this disclosure include (1) develop a treatment train by a sequential combination of UV/PS pre-treatment, a CDM process, microfiltration (MF), and RO to achieve antiscalant degradation for removal of scale-forming ions, mineral resources recovery, and additional water recovery from an inland brackish RO brine, (2) investigate operating conditions of UV/PS to degrade antiscalant in real brine (i.e., oxidant dose and UV irradiation time), (3) evaluate the effect of UV/PS pre-treatment on the subsequent CDM process with respect to removal of scale-forming ions and resources recovery, and (4) optimize water recovery from the RO brine.

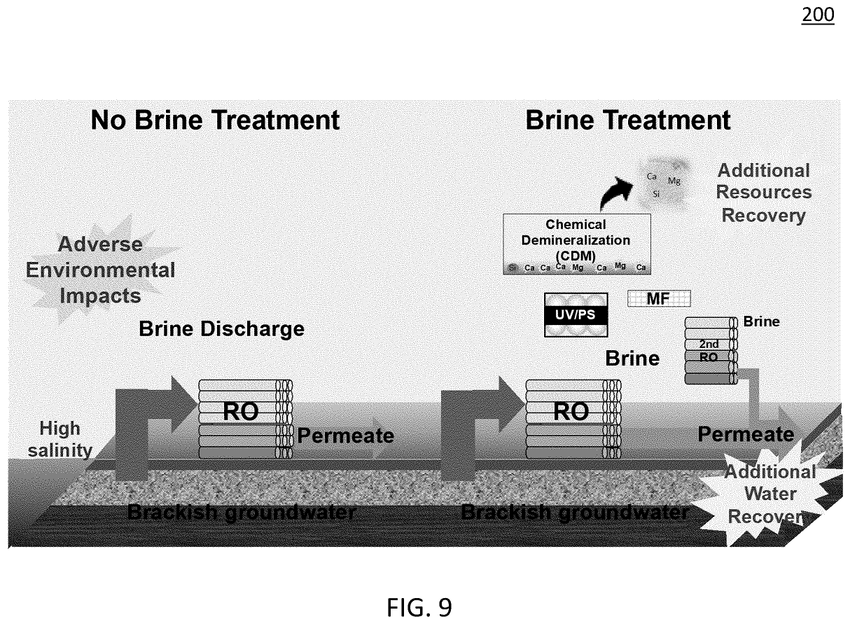

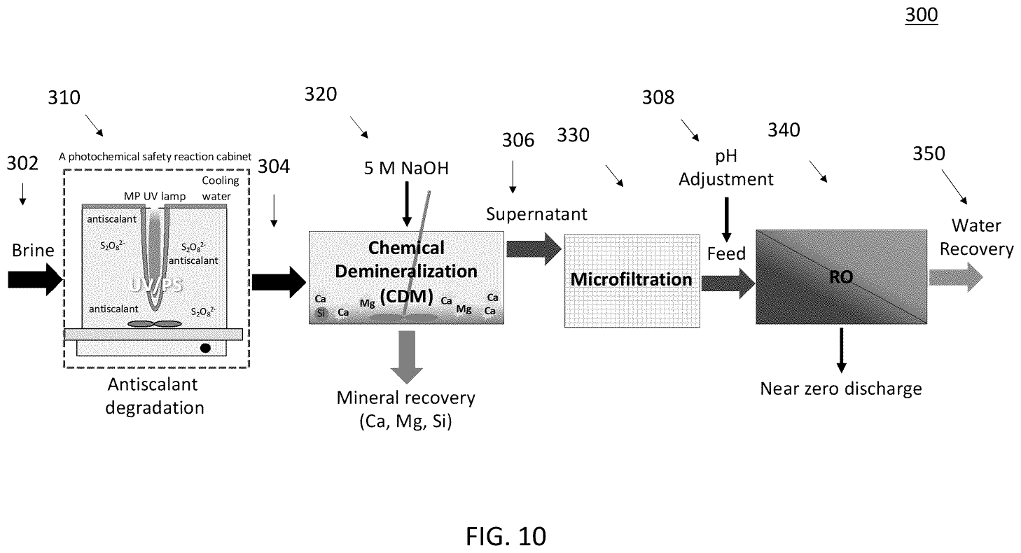

FIGS. 9 and 10 are illustrations of a comparison 200 of processes of no brine treatment versus a brin treatment in accordance with an exemplary embodiment, and a schematic 300 of sequential persulfate-based photochemical pre-treatment, chemical demineralization, microfiltration, and reverse osmosis (UV/PS-CDM-MF-RO) system, respectively. As shown in FIGS. 9 and 10, the system 300 can include a photochemical safety reaction cabinet 310 configured to receive a source of brackish desalination brine 302. The photochemical safety reaction cabinet 310 can include an ultraviolet UV lamp, for example, a medium-pressure (MP) UV lamp that generates UV-C energy with a range of 220 nm to 280 nm, and a source of coolant to cool the interior of the cabinet 310. The UV lamp is configured to perform antiscalant degradation on antiscalants in the source of brackish desalination brine 302 that includes a source of add persulfate, for example, in an amount of 0.5 mM to 4 mM. A chemical demineralization process 320 is then performed on the UV treated brine 320 to recover minerals, for example, calcium (Ca), magnesium (Mg), and silicon (Si). In accordance with an embodiment, a pH of the source of brackish desalination brine treated with the ultraviolet-driven persulfate oxidation pre-treatment 304 can be adjusted with, for example, sodium hydroxide (NaOH) before the chemical demineralization process. A supernatant 306 produced by the chemical demineralization process that is then treated with a microfilter process 330 to generate a feed 308 that can be treated with a reverse osmosis process 340 for water recovery 350. In accordance with an exemplary embodiment, the feed 308 from the microfiltration process 330 can be pH adjusted before the reverse osmosis treatment 340.

### Materials and Methods

### Brackish RO Brine Sampling and Water Quality Analysis

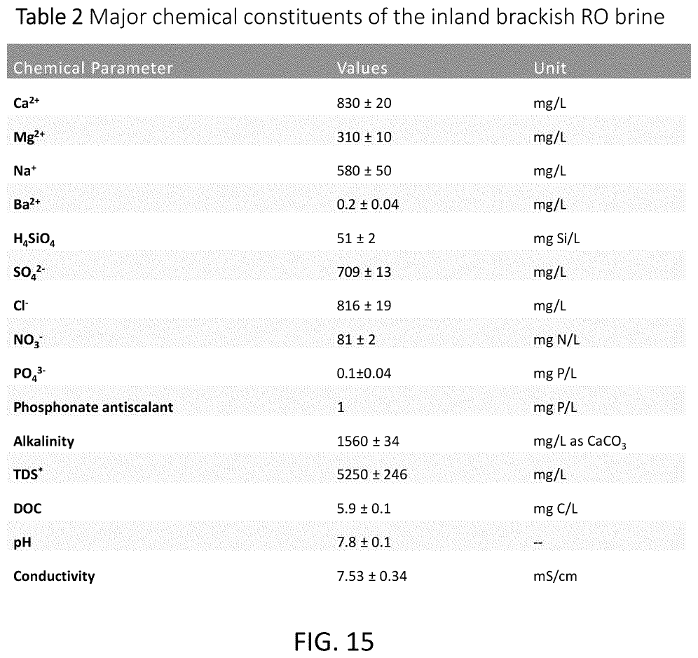

Inland brackish RO brine samples were collected from an Arlington Desalter in Riverside, California, via six sampling events. The brine sample contains a phosphonate antiscalant (Pretreat Plus® Y2K, King Lee Technologies, San Diego, CA) carried over from the primary RO desalination process. A fresh brine sample (40 L), sealed without headspace, was collected, and used for experiments within three days. Water quality parameters were measured, including pH, alkalinity, cation, and anion concentrations. Based on the measured water quality of RO brine, thermodynamic calculations (Visual Minteq, Version 3.1) were performed to predict the oversaturated minerals of the raw brine and brine at pH 10.2 in the absence of antiscalants. Specifically, the chemical composition of the brine (Table 2 (FIG. 15)) was input parameters to the chemical model in a closed system. The predicted oversaturated solids were subsequently selected and the theoretical type and amount of solid formation in the brine at equilibrium were calculated.

### Experiments on Brine Treatment

A 4-L beaker equipped with a 450 W medium pressure UV immersion lamp (Ace Glass, Inc.) served as a reactor for the UV/PS experiments. A 100 mM persulfate stock solution was prepared with Milli-Q 18 MΩ-cm water (Millipore, Bedford, MA, USA) and sodium persulfate (ACS grade, Avantor, Center Valley, PA). UV/PS experiments were conducted with a brine solution (3.5 L) containing 0.5 mM to 4 mM persulfate was prepared and transferred to the 4-L UV reactor. Three-mL samples were withdrawn by pipette from the reactor at designated time intervals for chemical analysis during UV irradiation that lasted up to 30 min.

CDM experiments were conducted with a 3.5-L raw brine sample that had been treated for 20 min by UV/PS with 1 mM persulfate. CDM control experiments were conducted without UV/PS pre-treatment. Subsequently, the UV/PS pre-treated, or control sample was transferred to a 4-L beaker. Precipitation of calcium and magnesium (major cations in brine) are primarily dictated by solution pH; therefore, 5 M NaOH was added to the brine without and with UV/PS pre-treatment to increase the pH to 10.2. After pH adjustment (T=0 min), the solution was rapidly mixed at 700 rpm with a stir bar for 1 min to promote chemical mixing and mineral precipitation, followed by a 30-min digestion period to facilitate the settling of precipitates. At targeted time intervals during the digestion period, 3-mL aliquots of the supernatant were withdrawn 3 cm below the water surface with a pipette, immediately acidified with 100 μL of concentrated HNO₃, and analyzed for the major cations. After settling of precipitates, the supernatant from the beaker was collected and vacuum filtered (0.45-μm polyvinylidene fluoride, 47 mm dia.) to remove of suspended precipitates. The filtered supernatant solution was used as a feedwater of the subsequent RO process. The residuals in the beaker, primarily the settled solids, were transferred to the metal pan and dried for 24 hours (h) at 105° C. to remove moisture for further characterization of the recovered minerals.

Secondary RO treatment was performed on three source waters under three conditions: CDM-MF filtrate at pH 10.2, raw brackish water RO brine at pH 7.8, and the raw brine at pH 5.0 (lowest allowable for antiscalant application). The pH of filtered supernatant from the CDM process (feedwater) was adjusted with 5 M HCl after the MF filtration. Raw brine sample were treated by RO as a control. The laboratory-scale RO was a crossflow system and operated for 24 h in partial recycling mode. RO membranes (BW30LE, DuPont FilmTec™, Edina, MN) commonly used for brackish water desalination were operated at a constant pressure of 150 psi. The permeate mass was continuously measured by an electronic balance and converted to normalized permeate water flux and water recovery rate. Total dissolved solids (TDS) of the permeate was measured at the end of the experiment. In addition, during the RO operation, 3-mL of feedwater and permeate were collected at the beginning, 12 hours (h), and 24 hours (h), acidified with 100 μL of concentrated HNO₃, and the removal rates of calcium, magnesium, and sodium were measured.

### Analytical Methods for Water and Solid Samples

Alkalinity of the raw brine was measured by titration based on Standard Method 2320B. The concentrations of chloride, nitrate, ammonium, and sulfate ions in the RO brine were determined by Standard Methods 4110B by ion chromatography (Dionex ICS-1100, Thermo Scientific, Sunnyvale, CA). The concentration of persulfate was determined by a standard colorimetric method using potassium iodide. The phosphonate antiscalant concentration in the brine sample was estimated by a persulfate photolysis degradation. The extent of antiscalant degradation was calculated by measuring the release of orthophosphate by Standard method 4500-P E. Major cations were measured using an inductively coupled plasma mass spectrometry (ICP-MS, Agilent 7700 Series, Santa Clara, CA). Triplicate measurements of each sample were conducted for all chemical parameters.

The weight of dried minerals of the settled precipitates of the CDM process was measured by a precision balance (ALF1202, Fisher Scientific, Hampton, NH). Dried minerals (50 mg) were digested by Standard Method 3005a. Concentrations of calcium, magnesium, and silica in the digests were measured using ICP-MS. The crystal structure of the minerals was determined by X-ray diffraction analysis (XRD) with Cu Ka radiation (Empyrean Series 2, Malvern Panalytical, United Kingdom), and chemical composition was evaluated by surface-sensitive X-ray photoelectron spectroscopy (XPS, Kratos AXIS Ultra DLD, Shimadzu, Japan).

### Results and Discussion

### Phosphonate Antiscalant Degradation by UV/Persulfate Oxidation

The major chemical constituents of the raw inland brackish RO brine collected and measured for study are displayed in Table 2 (FIG. 15). The pH 7.8 brine had an average TDS of 5250±246 mg/L and alkalinity of 1560±34 mg/L as CaCO₃. The major cations were calcium, magnesium, and sodium. The major anions were bicarbonate, sulfate, nitrate, and chloride. Sources of the hardness ions and bicarbonate were from mineral dissolution and equilibration with the groundwater in the aquifer. Historical agriculture activity and long-term application of fertilizer also introduced nitrate to the groundwater and consequently in the brine from RO treatment. The typical dosage of phosphonate antiscalant in RO feedwater ranges from 1 mg/L to 10 mg/L but the average measured concentration of phosphonate antiscalant in the brine was 23 mg/L, corresponding to 1 mg P/L. Thermodynamic calculations based on the chemical composition of the RO brine indicated that calcite (CaCO₃), dolomite (CaMg(CO₃)₂), and quartz (SiO₂) were supersaturated.

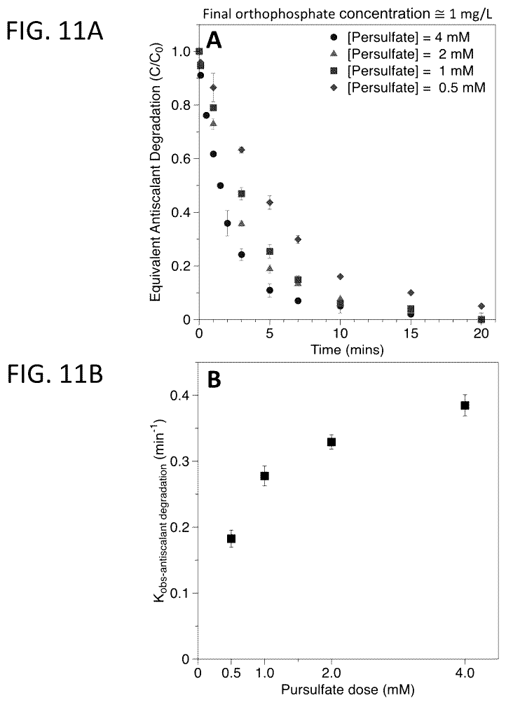

UV/PS pre-treatment degraded the phosphonate antiscalant to orthophosphate and exhibited distinct kinetics with different persulfate doses (FIG. 11A). For example, a persulfate dosage >1 mM degraded 100% of phosphonate within 20 min of UV irradiation; however, 0.5 mM persulfate was not sufficient to fully degrade the residual antiscalant in the RO brine. The generation of orthophosphate followed a pseudo-first-order kinetics model with rate constants between 0.18 min⁻¹ and 0.39 min⁻¹ that increased non-linearly with the increase of persulfate dosage indicating that the degradation rate decreased at higher persulfate dosage (FIG. 11B).

Persulfate is photolyzed directly to form two sulfate radicals (SO₄^{*-}) (Reaction 11), which can undergo hydrolysis to form hydroxyl radical (HO*) (Reaction 12, k=6.5×10⁷ M⁻¹s⁻¹)

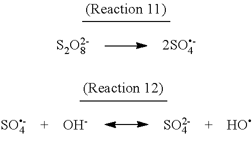

Both SO*₄⁻ and HO* degrade phosphonate antiscalants with second-order reaction rate constants of (2.9±0.6)×10⁷ M⁻¹s⁻¹ (Reaction 13) and (1.1±0.1)×10⁸ M⁻¹s⁻¹ (Reaction 14), respectively.

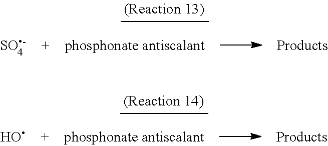

However, both SO*₄⁻ and HO* are scavenged by persulfate via Reactions 15 and 16, respectively, and generate a non-reactive persulfate radical (S₂O₈^{*-}). The second-order rate constants of Reaction 15 and 16 are 5.5×10⁵ M⁻¹s⁻¹ and 1.4×10⁷ M⁻¹s⁻¹, respectively:

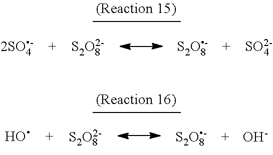

An increase in persulfate dosage promotes scavenging of the reactive radicals (Reaction 15 and 16); therefore, the correlation between the antiscalant degradation rate constant and the persulfate dosage deviated from linearity at a dosage higher than 2 mM. Thus, 1 mM persulfate with 20 min of UV irradiation was employed to achieve the highest efficiency in the utilization of persulfate, leaving only 5% of the persulfate in the UV reactor product.

Removal of Scale-Forming Ions from RO Brine by Chemical Demineralization

During the CDM process, the pH of the UV/persulfate pretreated RO brine was raised from 7.8 to 10.2 with NaOH, leading to a shift in the bicarbonate equilibrium to carbonate (Reaction 17). As a result, calcium carbonate precipitation actively occurred (Reaction 18, Kₛₚ=8.7×10⁻⁹ at 25° C.) and magnesium ion generated magnesium carbonate (Kₛₚ=1×10⁻⁵ at 25° C.). In addition, carbonate and hydroxide ions react with magnesium and calcium to form magnesium hydroxide (Reaction 19), Kₛₚ=8.9×10⁻¹² at 25° C.) and calcium-magnesium carbonate (Reaction 20), Kₛₚ=2.9×10⁻¹⁷ at 25° C.). Among possible magnesium precipitates, magnesium carbonate is highly soluble under the experimental condition; therefore, only magnesium hydroxide and calcium-magnesium carbonate precipitates were expected in UV/PS-treated brine at pH 10.2.

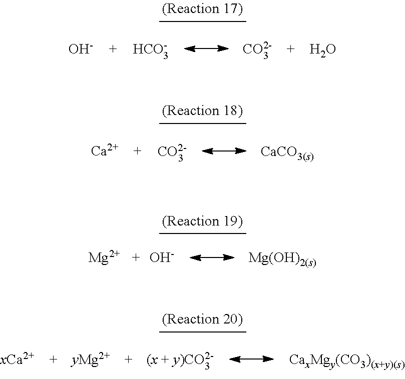

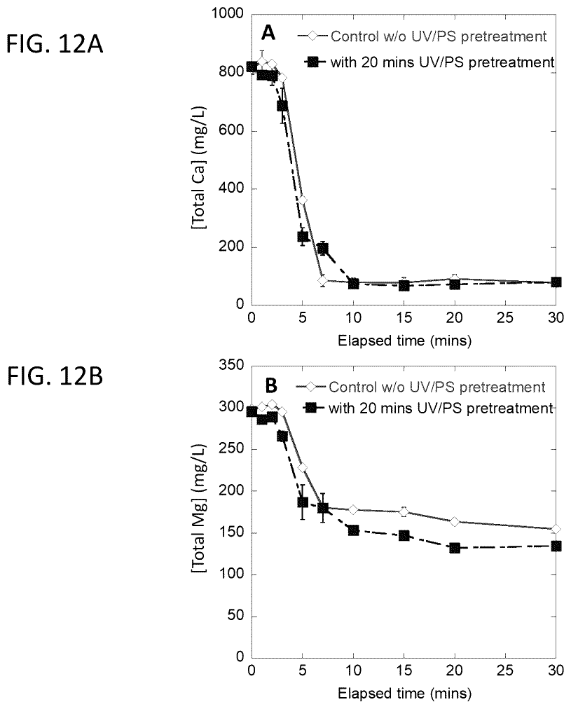

The impact of UV/PS pre-treatment on the calcium and magnesium removal efficiency from the brine by the CDM process was evaluated (FIGS. 12A and 12B). UV/PS pre-treatment improved the overall remove of hardness ions from the high-pH brine. When applied, calcium removal was approximately 16% more effective during the first 5 min of the CDM process (FIG. 12A), and the overall magnesium removal improved by 13% (FIG. 12B) by precipitation. Both the antiscalant manufacturer and a previous study indicated that the phosphonate antiscalant has a significant inhibition effect on the carbonate and metal oxide precipitates; however, this inhibition effect was marginally diminished after UV/PS pre-treatment due to phosphonate antiscalant degradation. As a result, more magnesium precipitation occurred in the CDM process with UV/PS pre-treatment. In addition, persulfate was not detected in the product water of the CDM process, indicating residual persulfate from the UV/PS pre-treatment is completely utilized during the CDM process.

Resources Recovery after Chemical Demineralization

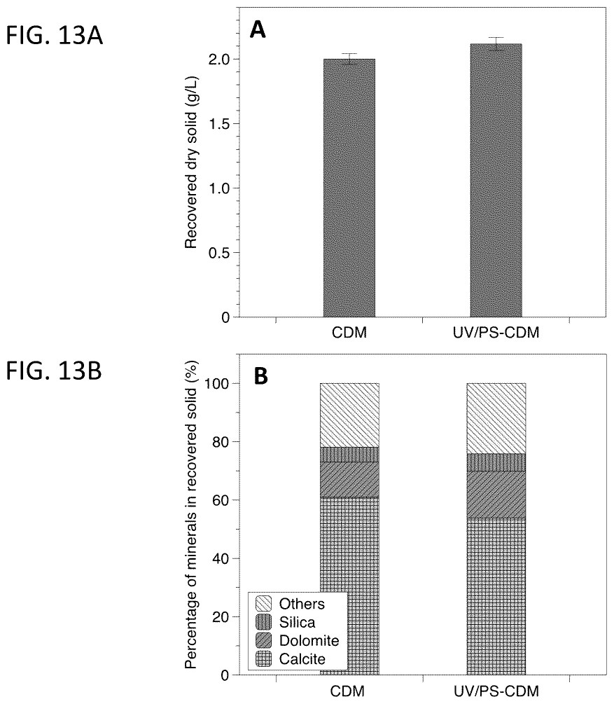

The quantity of recovered solids from the CDM process with and without UV/PS pre-treatment are presented in FIG. 13A and the composition of major cations in the solids after the digestion is shown in FIG. 13B. CDM without UV/PS pre-treatment resulted in 5% less mineral resources recovery than with UV/PS pre-treatment (FIG. 13A), which was consistent with the calcium and magnesium hardness removal data (FIGS. 12A and 12B). Thermodynamic calculations show the projected precipitation of calcite, dolomite, and quartz by CDM from brine in the absence of phosphonate antiscalant. Calcium in the form of calcite CaCO₃(s) accounted for over half of the dry mass (FIG. 13B). Other significant precipitates are dolomite CaMg(CO₃)₂(s) and quartz SiO₂(s). Compared to the control, the CDM process with UV/PS pre-treatment increased the mass percentage of recovered dolomite and quartz, mainly due to the fact that the UV/PS pre-treatment eliminated the scale inhibition effect of the phosphonate antiscalant (FIG. 12B).

In addition to the solid digestion, XPS analysis confirmed that calcium, magnesium, silica, and sodium were the major elements in the precipitates recovered from the CDM process. A greater proportion of magnesium and silica were recovered from the CDM process with UV/PS pre-treatment than without UV/PS pre-treatment. Results from the solid digestion and XPS analysis confirmed that the CDM process with UV/PS pre-treatment recovered more magnesium and silica. Degradation of phosphonate antiscalant via UV/PS likely affected the precipitation kinetics of Mg and Si solids to a larger extent than Ca solids, and consequently resulted in more magnesium and silica removal from the bulk solution. The presence of calcite, magnesium hydroxide Mg(OH)₂(s), and quartz were expected in the dried precipitates.

XRD measurements of the recovered minerals showed that the major recovered mineral was calcite from the CDM process both without and with UV/PS pre-treatment, which are expected from thermodynamic calculations and the XPS measurement. Though the presence of magnesium and silica was confirmed from solid digestion and XPS analyses, magnesium and silica related picks were indistinct in XRD patterns, indicating that silica and magnesium were not crystalline in structure so that the patterns are not observed in XRD measurement, or silica and magnesium patterns have been covered by calcite due to their relatively low amounts (FIG. 13B).

### Reverse Osmosis Performance Following Persulfate Photolysis and Chemical Demineralization

### Improvements in RO Permeate Flux and Water Recovery Following UV/PS Pre-Treatment and CDM

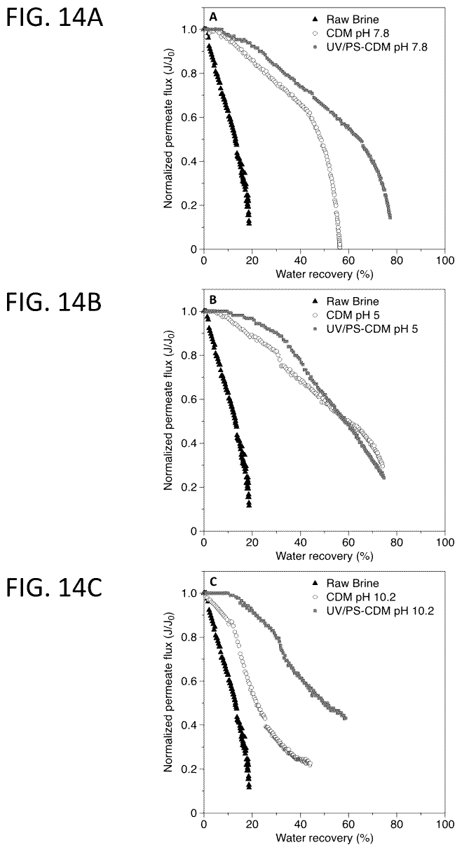

The normalized permeate flux declined as a function of water recovery for pH 5, 7.8, and 10.2 feed solutions from the CDM process without and with UV/PS pre-treatment (FIGS. 14A-14C). At the start of RO operation, the permeate flux without any pre-treatment (control, raw brine) decreased immediately, indicating that the presence of scale-forming ions in the untreated brine led to mineral scaling of the membrane (FIGS. 14A-14C). Application of the CDM process prior to RO reduced the decline in permeate flux, indicating membrane fouling mitigation (FIGS. 14A-14C). The CDM process removed the scale-forming ions and induced slower mineral scaling on the membrane surface.

For the RO feed solution from the CDM process with UV/PS pre-treatment, overall water recovery was 58.8%, 77.2%, and 74.6% at feedwater pH of 10.2, pH 7.8, and pH 5, respectively. On the other hand, the CDM process without UV/PS pre-treatment, overall water recovery was 44.1%, 56.4% and 74.1% at feedwater pH of 10.2, pH 7.8, and pH 5, respectively. More water recovery at pH 5 was expected because of the absence of carbonate ions, which is a major scaling inducer. Remarkably, the significant water recovery was achieved at pH 7.8 as well as pH 5 for the RO feed solution following the CDM process with UV/PS pre-treatment, which could be due to presence of less scale-forming ions in the RO feed solution following the CDM process with UV/PS pre-treatment. The CDM process with UV/PS pre-treatment was more effective than without pre-treatment when the pH of the RO feedwater was maintained at 10.2 or adjusted to 7.8. Moreover, the decline in normalized RO permeate flux was less severe in the treatment train assisted with UV/PS pre-treatment. The CDM process with UV/PS pre-treatment delayed mineral scaling and perhaps biofouling by removing residual antiscalant in the feedwater. In addition, the CDM process with UV/PS pre-treatment lowered the hardness concentration and improved the RO water yield. The RO feed solution from the CDM process with UV/PS pre-treatment were less sensitive to pH (FIGS. 14A-14C); therefore, pH of RO feed solution to acidic pH after UV/PS-CDM treatment is not needed, suggesting less acid consumption for pH adjustment of the feed water for the RO process.

### Impact of RO Process on Major Cations

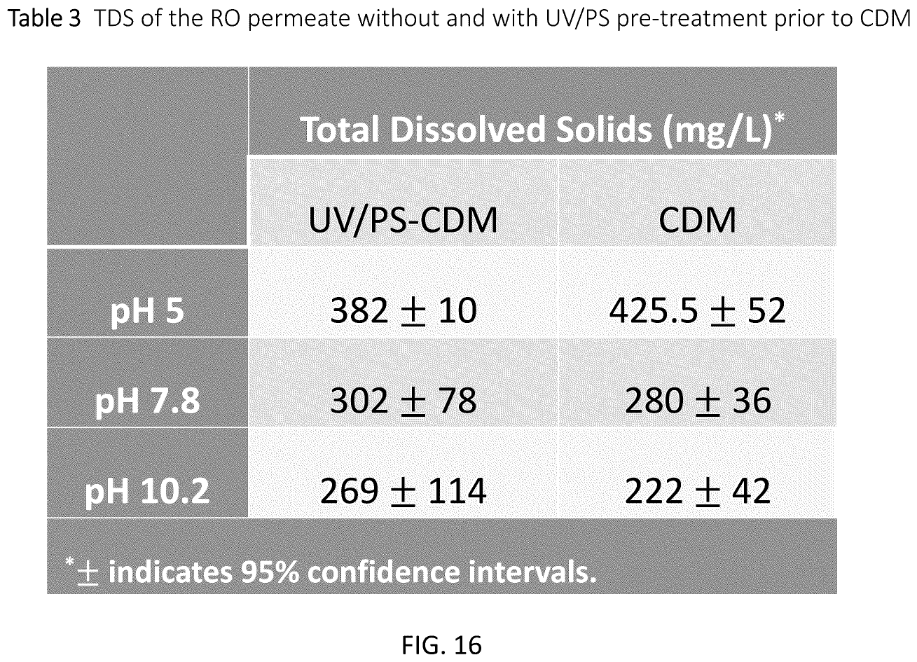

Total Dissolved Solids (TDS) of the RO permeate is shown in Table 3 (FIG. 16). TDS of the RO permeate were below 500 mg/L that meet the secondary drinking water quality standards of the U.S. Environmental Protection Agency (EPA). The removal efficiencies of calcium, magnesium, and sodium were similar regardless of UV/PS pre-treatment. The Filmtec BW30LE membrane is a low-energy polyamide membrane that is commonly applied to brackish water treatment to reduce salinity and has a negatively charged surface with a molecular weight cut-off of 100 Da. Accordingly, the removal efficiencies of calcium and magnesium are near 99% and the sodium removal efficiency for both RO permeates with UV/PS-CDM pre-treatment or CDM pre-treatment were 95%. Under the laboratory setup, membrane fouling increased with time and the feed water became concentrated; however, the measured removal rates were consistent throughout the RO operation, suggesting that the fouling layer and feed concentration had little impact on efficiency of ion removal.

In accordance with exemplary embodiment, a complete RO brine treatment system with UV/PS pre-treatment, chemical demineralization (CDM), microfiltration (MF), and reverse osmosis (RO) can achieve: (1) antiscalant degradation (UV/PS), (2) resources recovery (CDM), and (3) additional water recovery (RO) from the brine from a brackish water desalination plant. The experimental results confirmed that the brine treatment system is a promising technology to recovery additional water and mineral resources. The CDM process with UV/PS pre-treatment resulted in greater magnesium and silica removal efficiencies due to phosphonate antiscalant degradation and mitigated membrane fouling in the secondary RO process due to the lower concentration of magnesium, silica, and phosphonate antiscalant in the RO feed solution. In addition, the UV/PS pre-treatment and CDM produced a RO feed water that resulted in high water recovery at neutral pH; therefore, less acid is needed for pH adjustment of the feed water and to add additional base to the RO permeate to bring the pH back to the neural. Collectively, the suggested system in this study can help achieve a near zero liquid discharge goal in the inland brackish water treatment plant and improve the sustainability of the desalination plant.

The detailed description above describes embodiments of a method and system for treatment of brackish water inland desalination brine and recoveries of minerals and fresh water using persulfate, chemical demineralization, and membrane separation. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

What is claimed is:

1. A method for treating brackish desalination brine, the method comprising:
treating a source of brackish desalination brine with an ultraviolet-driven persulfate photolysis oxidation pre-treatment;
treating the source of brackish desalination brine treated with the ultraviolet-driven persulfate photolysis oxidation pre-treatment to a chemical demineralization process;
treating the source of brackish desalination brine treated with the ultraviolet-driven persulfate photolysis oxidation pre-treatment and with the chemical demineralization process to a microfiltration process; and
treating the source of brackish desalination brine treated to the ultraviolet-driven persulfate photolysis oxidation pre-treatment, the chemical demineralization process, and the microfiltration process to a reverse osmosis treatment.

2. The method according to claim 1, further comprising:
promoting antiscalant degradation with the ultraviolet-driven persulfate photolysis oxidation pre-treatment of the source of brackish desalination brine.

3. The method according to claim 1, further comprising:
precipitating scale-forming precursor removal of minerals from the source of brackish desalination brine with the chemical demineralization process.

4. The method according to claim 1, further comprising:
precipitating scale-forming calcium from the source of brackish desalination brine during the chemical demineralization process.

5. The method according to claim 1, wherein the ultraviolet-driven persulfate photolysis oxidation pre-treatment comprises:
adding persulfate to the source of brackish desalination brine; and
exposing the source of brackish desalination brine with the persulfate to a source of ultraviolet irradiation.

6. The method according to claim 5, further comprising:
exposing the source of brackish desalination brine with the persulfate to the ultraviolet irradiation for a period of time not to exceed 60 minutes.

7. The method according to claim 5, further comprising:
adding the persulfate to the brackish desalination brine in an amount of 0.5 mM to 4 mM.

8. The method according to claim 1, further comprising:
adjusting a pH of the source of brackish desalination brine treated with the ultraviolet-driven persulfate photolysis oxidation pre-treatment with sodium hydroxide (NaOH) before the chemical demineralization process.

9. The method according to claim 1, further comprising:
adjusting a pH of the source of brackish desalination brine treated with the ultraviolet-driven persulfate photolysis oxidation pre-treatment with calcium hydroxide (Ca(OH)₂) and sodium hydrogen carbonate (NaHCO₃) before the chemical demineralization process.

10. The method according to claim 1, further comprising:
adjusting a pH of the source of brackish desalination brine treated with the ultraviolet-driven persulfate photolysis oxidation pre-treatment with one or more alkaline chemicals before the chemical demineralization process, the one or more alkaline chemicals selected from one or more of calcium oxide (CaO), calcium hydroxide (Ca(OH)₂), sodium hydroxide (NaOH), sodium hydrogen carbonate (NaHCO₃), sodium carbonate (Na₂CO₃).

11. The method according to claim 1, further comprising:
removing a quantity of one or more of calcium, magnesium, and silicon from the source of brackish desalination brine from the chemical demineralization process.

12. The method according to claim 1, wherein the source of brackish desalination brine is an inland desalination brine containing antiscalant and scale-forming precursors.

13. A method for treating brackish desalination brine for a reverse osmosis treatment for recovery of fresh water, the method comprising:
treating a source of brackish desalination brine with an ultraviolet-driven persulfate photolysis oxidation pre-treatment, the ultraviolet-driven persulfate photolysis oxidation pre-treatment includes adding persulfate to the source of brackish desalination brine, and exposing the source of brackish desalination brine with the persulfate to ultraviolet irradiation;
adjusting a pH of the source of brackish desalination brine treated with the ultraviolet-driven persulfate photolysis oxidation pre-treatment;
treating the pH adjusted source of brackish desalination brine to a chemical demineralization process; and
treating the source of brackish desalination brine treated with the chemical demineralization process to a microfiltration process.

14. The method according to claim 13, further comprising:
adding the persulfate to the brackish desalination brine in an amount of 0.5 mM to 4 mM.

15. The method according to claim 13, further comprising:
adjusting the pH of the source of brackish desalination brine treated with the ultraviolet-driven persulfate photolysis oxidation pre-treatment with sodium hydroxide (NaOH) before the chemical demineralization process.

16. The method according to claim 13, further comprising:
adjusting a pH of the source of brackish desalination brine treated with the ultraviolet-driven persulfate photolysis oxidation pre-treatment with calcium hydroxide (Ca(OH)₂) and sodium hydrogen carbonate (NaHCO₃) before the chemical demineralization process.

17. The method according to claim 13, further comprising:
adjusting the pH of the source of brackish desalination brine treated with the ultraviolet-driven persulfate photolysis oxidation pre-treatment with one or more alkaline chemicals before the chemical demineralization process, the one or more alkaline chemicals selected from one or more of calcium oxide (CaO), calcium hydroxide (Ca(OH)₂), sodium hydroxide (NaOH), sodium hydrogen carbonate (NaHCO₃), sodium carbonate (Na₂CO₃).

18. The method according to claim 13, further comprising:
removing a quantity of one or more of calcium, magnesium, and sodium from the source of brackish desalination brine from the chemical demineralization process.

19. A system for recovering fresh water from a source of brackish desalination brine, the system comprising:
a source of ultraviolet light, the source of ultraviolet light configured to treat the source of brackish desalination brine with added persulfate to an ultraviolet-driven persulfate photolysis oxidation pre-treatment process;
a chemical demineralization system configured to treat the source of brackish desalination brine treated with the ultraviolet-driven persulfate photolysis oxidation pre-treatment to a chemical demineralization process;
a microfiltration system, the microfiltration system configured to separate the source of brackish desalination brine treated with the ultraviolet-driven persulfate photolysis oxidation pre-treatment and with the chemical demineralization process into solids and a liquid; and
a reverse osmosis system configured to treating the liquid from microfiltration process with a reverse osmosis treatment to recover water from the liquid.

20. The system according to claim 19, wherein
a pH of the source of brackish desalination brine in the chemical demineralization system is adjusted with sodium hydroxide (NaOH) before the chemical demineralization process, adjusted with calcium hydroxide (Ca(OH)₂) and sodium hydrogen carbonate (NaHCO₃), or adjusted with one or more alkaline chemicals before the chemical demineralization process, the one or more alkaline chemicals selected from one or more of calcium oxide (CaO), calcium hydroxide (Ca(OH)₂), sodium hydroxide (NaOH), sodium hydrogen carbonate (NaHCO₃), sodium carbonate (Na₂CO₃); and
the chemical demineralization process is configured to remove a quantity of one or more of calcium, magnesium, and sodium from the source of brackish desalination brine.
